(19) United States
(12) Patent Application Publication
(10) Pub. No.: US 2017/0372384 A1
(43) Pub. Date: Dec. 28, 2017

(54) METHODS AND SYSTEMS TO DYNAMICALLY PRICE INFORMATION TECHNOLOGY SERVICES

(71) Applicant: VMware, Inc., Palo Alto, CA (US)

(72) Inventors: Al Yaros, Herzliya (IN); Eyal Cohen, Herzliya (IN)

(73) Assignee: VMware, Inc., Palo Alto, CA (US)

(21) Appl. No.: 15/356,603

(22) Filed: Nov. 20, 2016

Related U.S. Application Data
(60) Provisional application No. 62/355,173, filed on Jun. 27, 2016.

(51) Int. Cl. G06Q 30/02; H04L 29/08; G06Q 10/06

(52) U.S. Cl. CPC G06Q 30/0283; G06Q 10/0631; H04L 67/10

(57) ABSTRACT

Methods and systems to dynamically calculate pricing of IT services provided by a cloud-computing facility are described. A number of different price plans that are constrained to a given policy are generated. Given the generated price plans an optimal price plan is determined. Methods also determine an optimal price plan as a balance between costs of cloud-computing resources used to execute a customer's application program, such as IaaS and PaaS, application program performance, and application program business value, resulting in an optimal price plan for the data center customer.

### CROSS-REFERENCE TO RELATED APPLICATION

This application claims the benefit of Provisional Application No. 62/355,173, filed Jun. 27, 2016.

### TECHNICAL FIELD

The present disclosure is directed to dynamically calculating prices of information technology services provided by a cloud-computing facility.

### BACKGROUND

Cloud-computing facilities provide computational bandwidth and data-storage services, called information technology (“IT”) services, much as utility companies provide electrical power and water to consumers. Cloud computing provides enormous advantages to customers without the devices to purchase, manage, and maintain in-house data centers. Such customers can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, customers can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a customer. However, because cloud-computing facilities are regularly adding new services, refreshing legacy hardware, and adapting to changes in a competitive market, manually determining prices of IT servers has become an impossible task. As a result, prices of IT services are relatively static and are typically not tested or explored to achieve a best price over time.

### SUMMARY

Methods and systems to dynamically calculate pricing of information technology (“IT”) services provided by a cloud-computing facility are described. A number of different price plans that are constrained to a given policy are generated. Given the generated price plans an optimal price plan is determined. Methods also determine an optimal price plan as a balance between costs of cloud-computing resources used to execute a customer's application program, such as IaaS and PaaS, application program performance, and application program business value, resulting in an optimal price plan for the data center customer.

### DESCRIPTION OF THE DRAWINGS

FIG. 1 shows a general architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machine and virtual-machine execution environments.

FIG. 6 shows an example of an open virtualization format package.

FIG. 7 shows virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows a price plan represented as matrix.

FIGS. 12A-12B shows examples of price plans.

FIG. 13 shows an example plot of prices of an information technology services over time.

FIG. 14 shows an example of a price plan policy.

FIG. 15 shows a set of price plans.

FIG. 16 shows a table of rewards for a set of price plans.

FIG. 17 shows a control-flow diagram of a method to calculate price for information technology services in a cloud-computing infrastructure.

FIG. 18 shows a control-flow diagram of the routine “determine optimal price plan” called in FIG. 17.

FIG. 19 shows a control-flow diagram of the routine “identify optimal price plan” called in FIG. 18.

### DETAILED DESCRIPTION

A general description of physical data centers, hardware, virtualization, VMs, and virtual data centers are described in a first subsection. Methods and systems to dynamically calculate pricing of information technology (“IT”) services provided by a cloud-computing facility are described in a second subsection.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and VMs, communications interfaces, and many of the other topics discussed below are tangible, physical components of physical, electro-optical-mechanical computer systems.

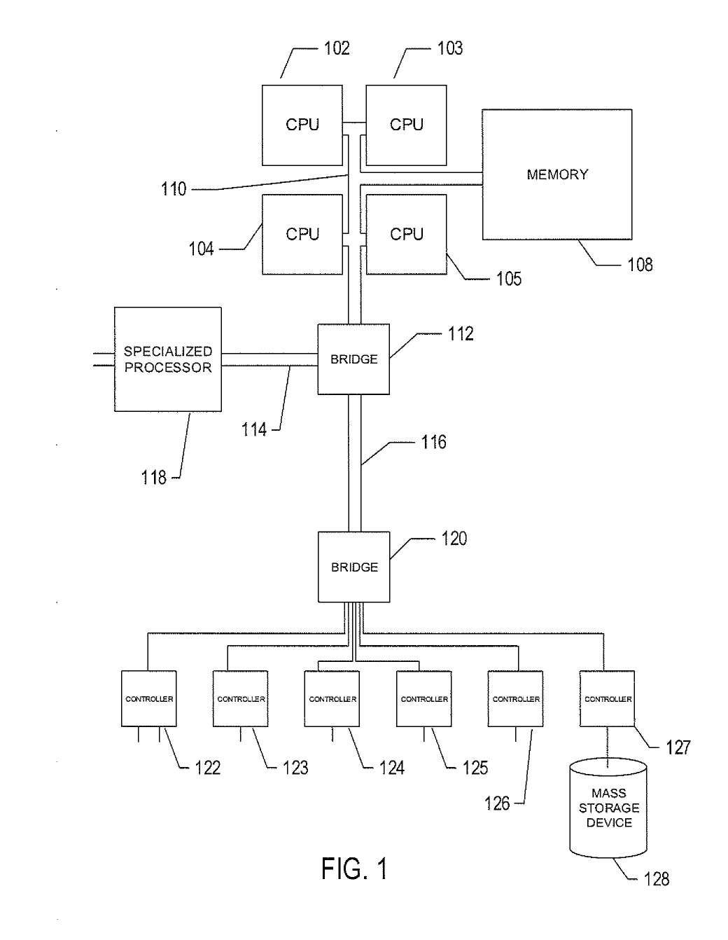

FIG. 1 shows a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

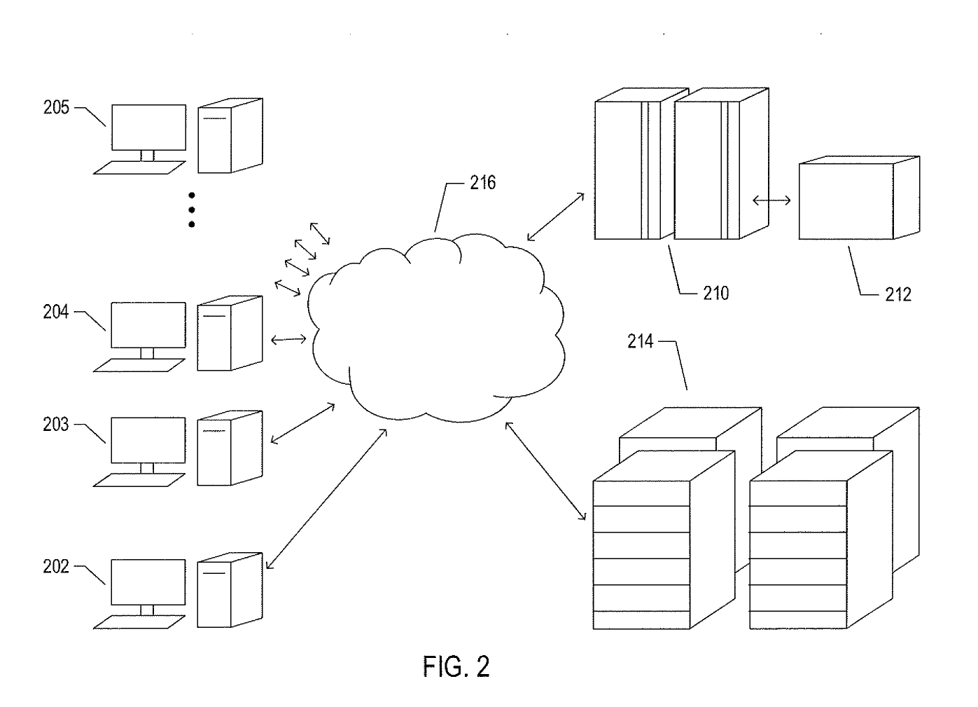

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

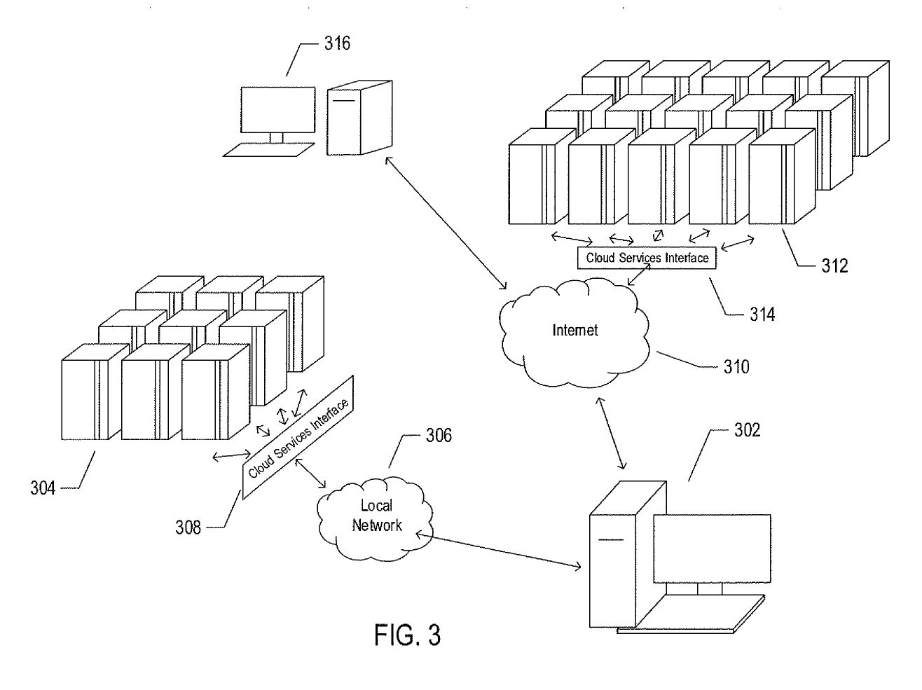

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

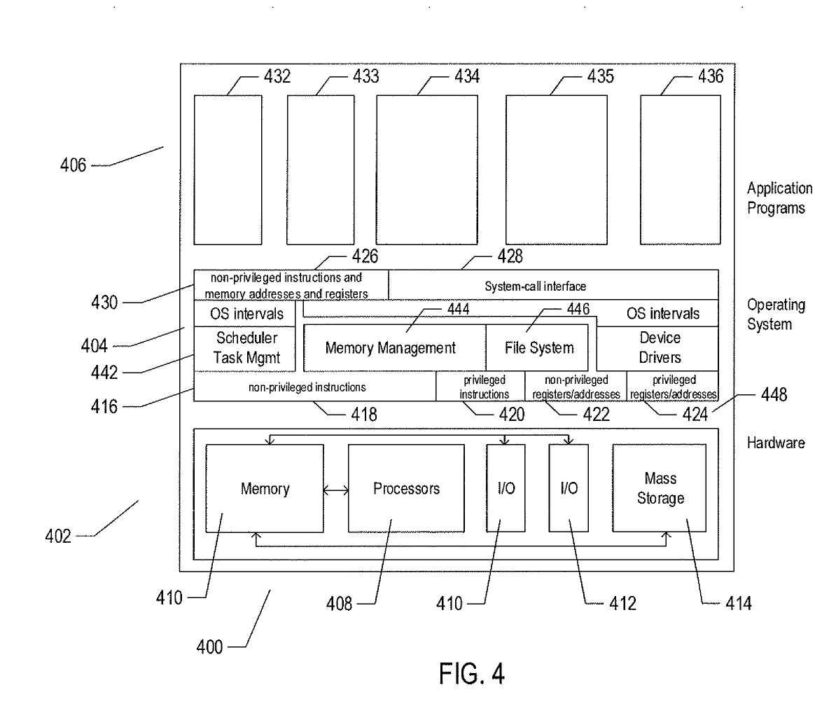

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

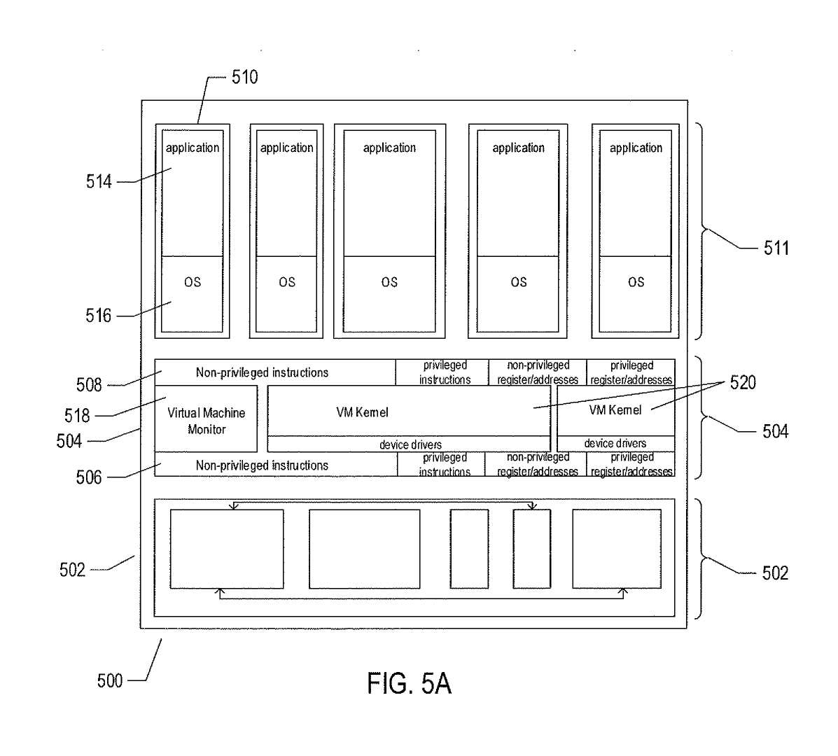

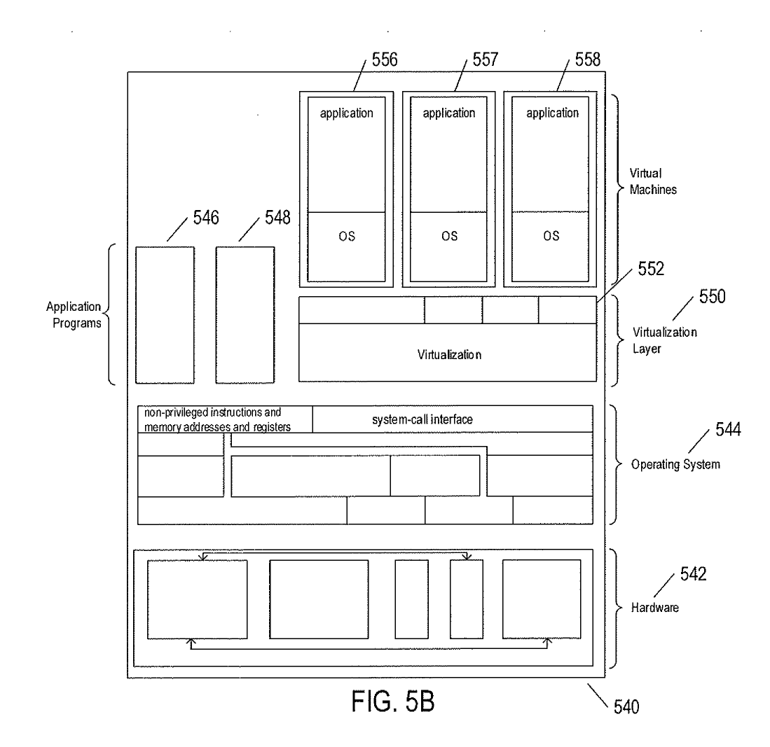

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface 508 to a number of VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization-layer interface 508 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization-layer interface 508 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization-layer interface 508, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In Figure SB, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

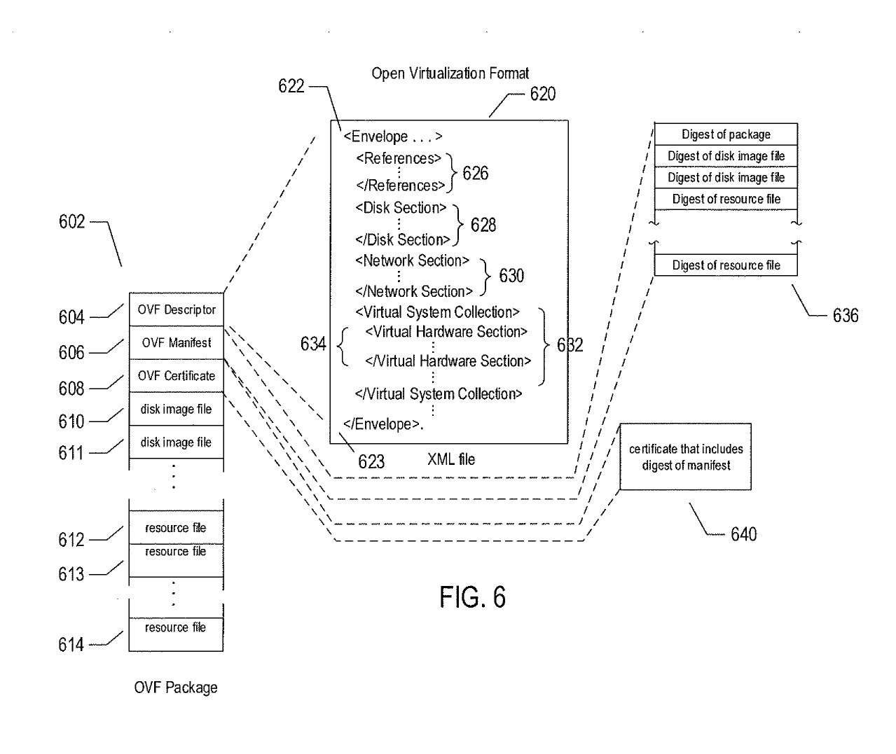

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or entirely eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

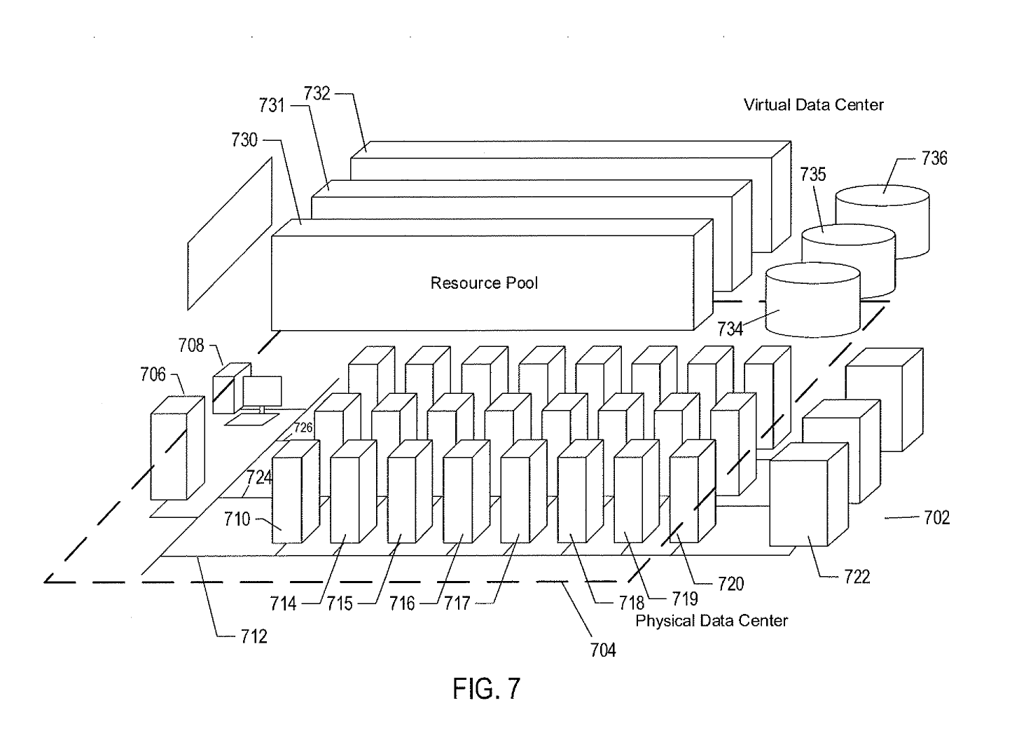

FIG. 7 shows virtual data centers provided as an abstraction of underlying physical-data-center hardware components. In FIG. 7, a physical data center 702 is shown below a virtual-interface plane 704. The physical data center consists of a virtual-data-center management server 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of physical servers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server 706 includes functionality to migrate running VMs from one physical server to another in order to optimally or near optimally manage device allocation, provide fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual physical servers and migrating VMs among physical servers to achieve load balancing, fault tolerance, and high availability.

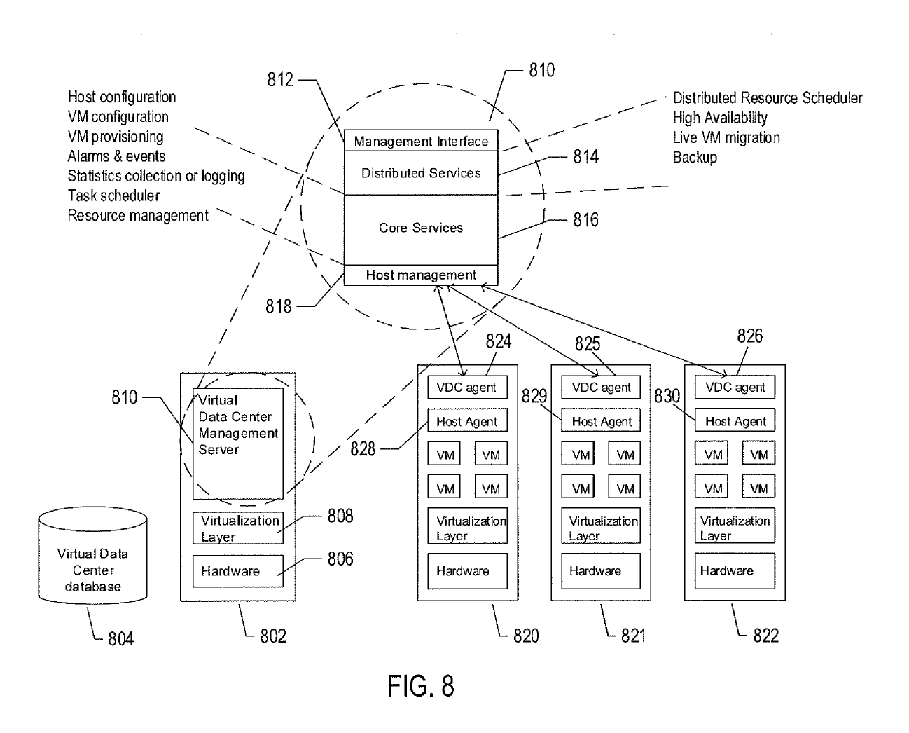

FIG. 8 shows virtual-machine components of a virtual-data-center management server and physical servers of a physical data center above which a virtual-data-center interface is provided by the virtual-data-center management server. The virtual-data-center management server 802 and a virtual-data-center database 804 comprise the physical components of the management component of the virtual data center. The virtual-data-center management server 802 includes a hardware layer 806 and virtualization layer 808, and runs a virtual-data-center management-server VM 810 above the virtualization layer. Although shown as a single server in FIG. 8, the virtual-data-center management server (“VDC management server”) may include two or more physical server computers that support multiple VDC-management-server virtual appliances. The VM 810 includes a management-interface component 812, distributed services 814, core services 816, and a host-management interface 818. The management interface 818 is accessed from any of various computers, such as the PC 708 shown in FIG. 7. The management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the physical servers of the physical data center that is abstracted to a virtual data center by the VDC management server.

The distributed services 814 include a distributed-device scheduler that assigns VMs to execute within particular physical servers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server, and restarts the VM on the different physical server from a virtual-machine state recorded when execution of the VM was halted. The distributed services 814 also include a distributed backup service that provides centralized virtual-machine backup and restore.

The core services 816 provided by the VDC management server 810 include host configuration, virtual-machine configuration, virtual-machine provisioning, generation of virtual-data-center alarms and events, ongoing event logging and statistics collection, a task scheduler, and a device-management module. Each physical server 820-822 also includes a host-agent VM 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce device allocations made by the VDC management server 810, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

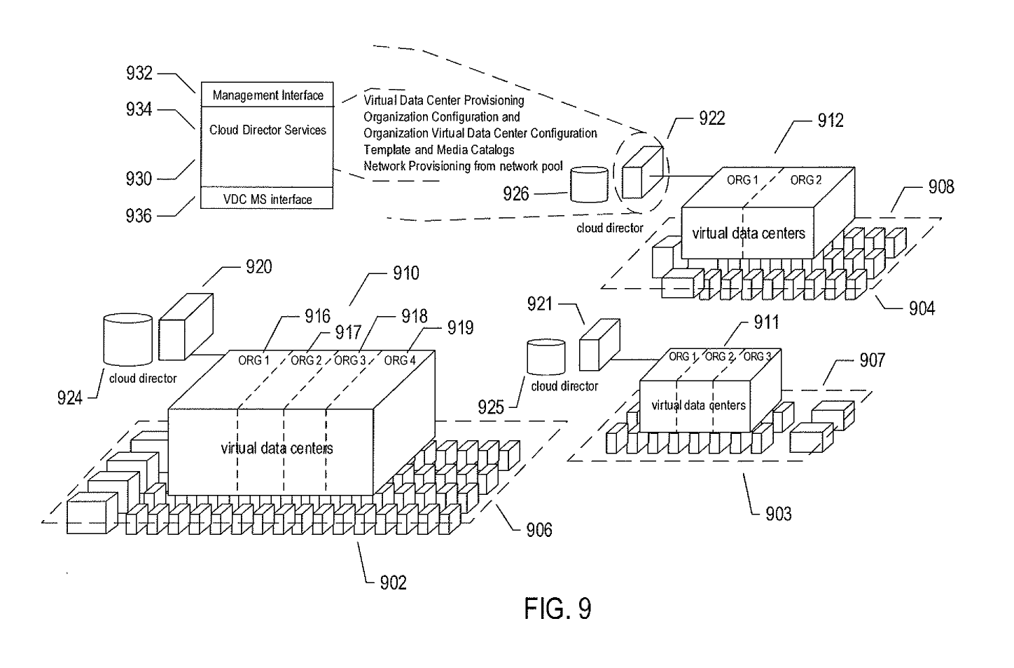

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

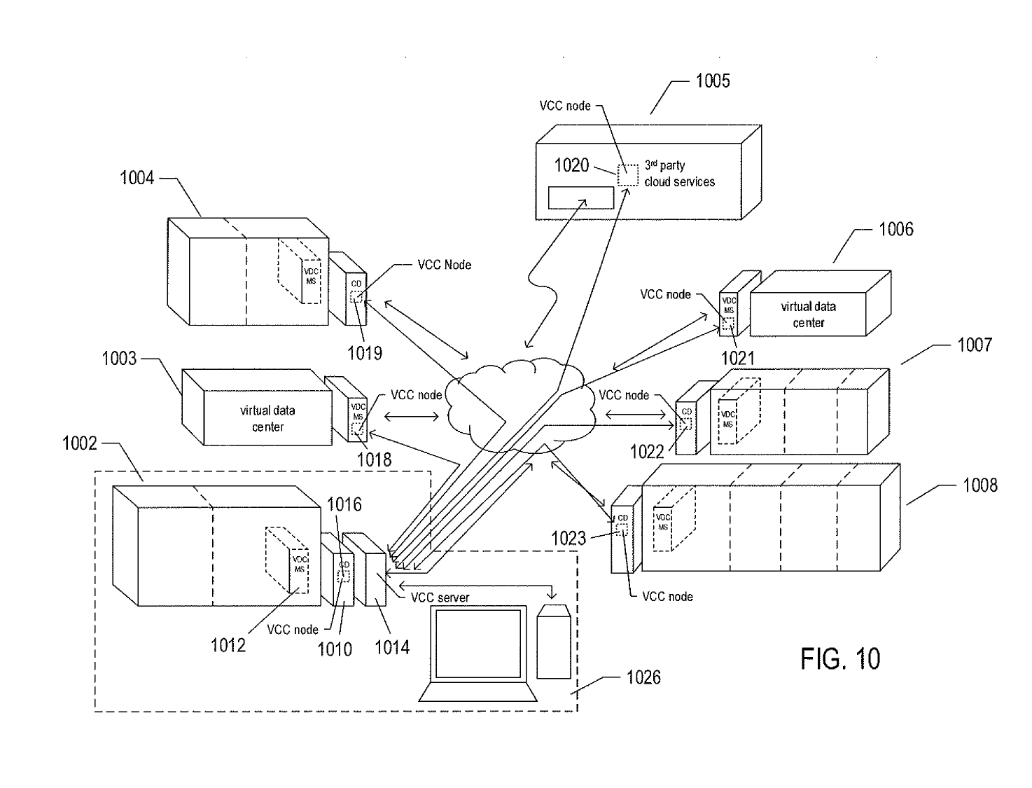

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Methods to Dynamically Calculate Pricing of Information Technology Services

Information technology (“IT”) organizations that manage cloud-computing facilities create cost models that enable the IT organizations to determine actual costs of IT services provided to IT customers. A cost is an amount of money an IT service provider that manages the cloud-computing facility spends in order to provide an IT service. An IT service provider provides IT services, such as infrastructure as a server (“IaaS”), platform as a service (“PaaS”), email service, ticket tracking system, to an IT customer according to a service-level agreement (“SLA”) between the IT service provider and the IT customer. An SLA may be a contract or agreement between the IT service provider and the IT customer. Particular aspects of an SLA may include, but are not limited to, a description of the suite of services provided by the IT service provider, such as file storage and sharing, authentication, type and number of physical and virtual server hosts, data backup and recovery, response times, and resolution times.

IaaS is a services that abstracts the user from cloud infrastructure details, such as physical computing resources, location, data partitioning, scaling, security, and backup. A VMM runs the VMs as guests and pools of VMMs within the cloud-computing facility can support large numbers of VMs and the ability to scale services up and down according to customers' varying requirements. IaaS includes running application programs in isolated partitions, called “containers,” directly on the physical hardware. Namespaces are the underlying kernel technologies used to isolate, secure and manage the containers and container capacity auto-scales dynamically with computing load, which eliminates the problem of over-provisioning and enables usage-based billing.

PaaS is a development environment for application developers. The cloud-computing provider may develop toolkits and standards for development and channels for distribution and payment. Cloud-computing providers deliver a computing platform, typically including operating system, programming-language execution environment, database, and web server. Application developers can develop and run their application in a cloud-computing facility without the cost and complexity of buying and managing the underlying hardware and application layers.

Each service has an associated unit. For example, an email service unit may be inbox. An IaaS unit may be a medium size VM. Other services may be broken down into even smaller units. For example, such as CPU hours, memory hours, and network bandwidth. Once the total cost of a service (i.e., serviceCost) and the number of units of the server (i.e., numberUnits) are known, unit cost of the service is calculated by dividing the total cost of the service by the number of units:

$$unitCost of Service = \frac{serviceCost}{numberUnits} \qquad ( 1 )$$

Once the unit cost of each service is calculated, IT service providers can decide to offer their services to different business units and IT consumers by specifying a unit price for each service. A unit price is an amount of money an IT service provider charges an IT customer for a unit of IT service. For example, a unit price of an IT service may be given by unitPrice of Service=Margln+unitCost of Service, where “Margin” is the profit margin. The unit price in some cases may be equal to the unit cost of the service (i.e., Margin=0). But, in other case, the unit price may be larger or smaller than the unit cost of the service depending the types of business metric the IT service provider wants to maximize and the margin of profit the IT service provider wants to make. For example, an IT service provider may want to maximum profit, usage, or recovery of costs. Once a unit price is determined, an IT service provider charges the various business units according to their unit usage volumes multiplied by the defined unit price.

An IT service provider may create personalized price plans for each IT customer. A personalized price plan enables an IT service provider to offer different prices to different business units. A price plan may be represented by a matrix where each matrix element is a price of a service for a business unit.

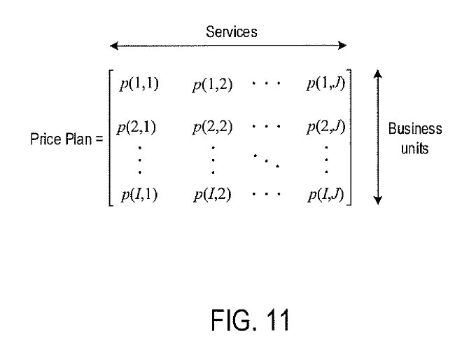

FIG. 11 shows a price plan represented as an I×J matrix, where I represents the number of business units, and J represents the number of services. Each row corresponds to a business unit, and each column corresponds to a particular service provided by cloud-computing facility. Each element, p(i,j), represents the price of the i-th service for the j-th business unit.

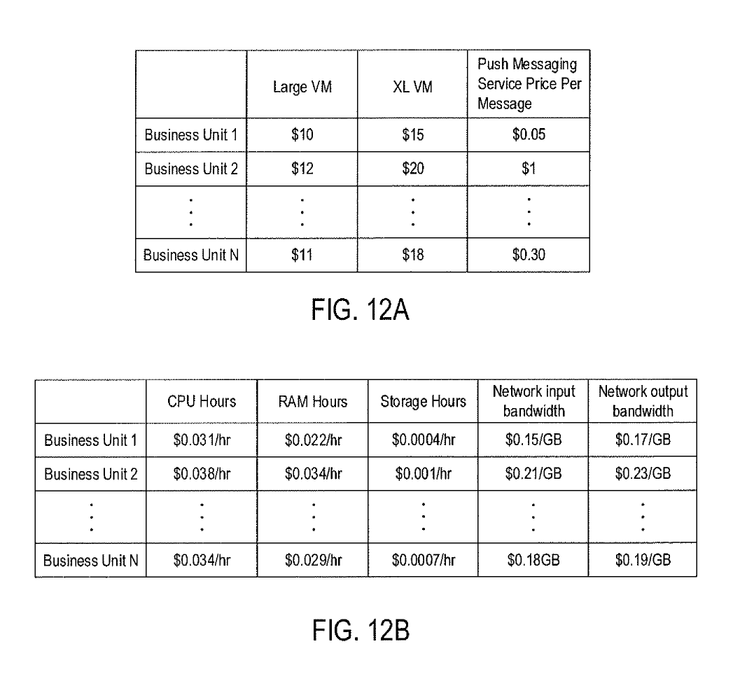

A price plans can be broken down in any number of different ways, such as different levels of services offered to customers. FIG. 12A shows a high-level price plan for two different VM sizes (i.e., large and extra large) and push notifications for N different business units. In this example, the services are different size VMs and push notifications. FIG. 12B shows a lower-level price plan based on CPU hours, RAM hours, storage hours, and network I/O. The services are CPU time, RAM time, storage time, and amount of I/O gigabites.

IT service providers may publish a price plan on one or more occasions during a year. For example, IT service providers may decide to publish a price plan once a year during budget creation, once a quarter, or when an important event has taken place, such as adding a new service to a catalog of services, refreshing legacy hardware, major changes to cost drivers of the cloud-computing facility, and market changes.

A target function represents a quantitative measure of success of a price of a service. The target function is a business metric a cloud-computing facility wants to maximize. An IT service provider may have different target functions that promote different business objectives for different customers. A target function may include usage volume, profits, and recovery rate. A usage volume target function encourages business units to increase usage of IT services in order to achieve greater efficiency and encourage business units to decrease their usage of IT services when services are decommissioned. A profit target function maximizes profits of IT services. A recovery target function maximizes a recovery rate.

Methods to determine an optimal price plan may be implemented by first generating price plans that are constrained to a price plan policy. Given the number of different price plans, an optimal price plan that maximizes a selected target function, while also providing added value for the various IT business units is determined. The optimal price plan is then used to charge IT customers for IT services.

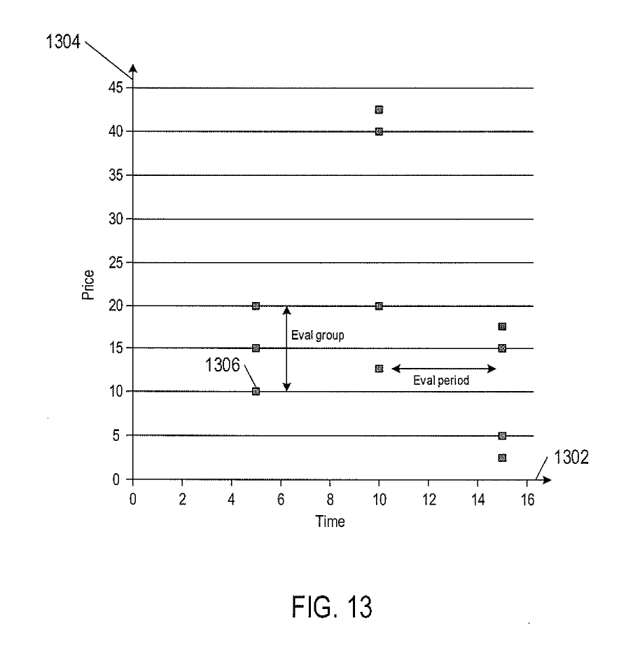

FIG. 13 shows an example plot of prices of an IT service over time in hours. Horizontal axis 1302 represents time in hours. Vertical axis 1304 represents price. Square, such as square 1306, represent the price of the IT service at a particular time.

Consider a business unit that maintains a sets of web servers and computation nodes in a cloud-computing infrastructure using IaaS and PaaS services. The business unit uses a customer agent, which is an automated process that performs automatic scaling of web servers or other computation nodes. For example, the customer agent performs auto scale of resources, such as servers and VM's, based on resource loads and demands. Certain customer agents may consider costs as well. The customer agent may balance costs of the resources, web application performance, and web application business value. The customer agent performs analysis of price plans of different external and internal cloud computer IT service providers and decides in real time which cloud computing IT server provider to use and the usage volumes. From the IT service provider perspective, the price plans are dynamically assigned so that the IT customer might select service provider X at time t and at a later time (e.g., t+1 minute later, t+10 minutes, t+1 hour, or, t+1 day) might select service provider Y. This example sets the stage for the method of dynamic IT services pricing as described below. While the customer agent takes the optimal decisions for the IT customer, the service provider explores and exploits an optimal price plan and maximizes a target function.

A set of price plans are generated based on a price plan policy that may be agreed upon in the SLA An IT financial manager creates a price plan policy after considering cost structures, competitor's prices, profit margins, and other metrics. The price plan policy is used to define price boundaries for each price of an IT service and provides predictability to the IT customers by sharing the maximum possible price. The price plan policy is a rule-based system where the service provider defines base values and a set of rules that the system can use to generate and explore price plans within the defined boundaries of the price plan policy. A price plan policy may also include default business unit prices that describes a price plan for a new business unit that has not been modeled in the past.

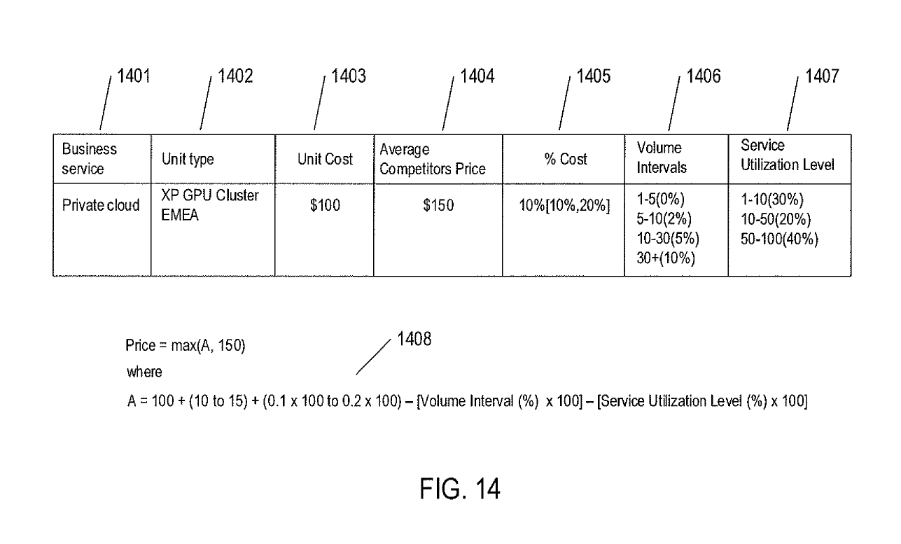

FIG. 14 shows an example of a price plan policy for a private cloud offered as a business service 1401. The unit type 1402 is a cluster of graphical processing units (“GPUs”) at a unit cost of $100 1403. Average competitor prices 1404 for the same cluster of graphical processing units is $150. The price plan policy includes % costs 1405, volume intervals 1406, and service utilization levels 1407. FIG. 14 also shows an example of a price calculated according to equation 1408.

The price plan policy may be used to generate a set of K price plans for business units based on each business unit's historical usage of data and service utilization metrics. Price plan generation processes may occur many times during the lifecycle of a service in order to constantly adopt a best price plan at any given time.

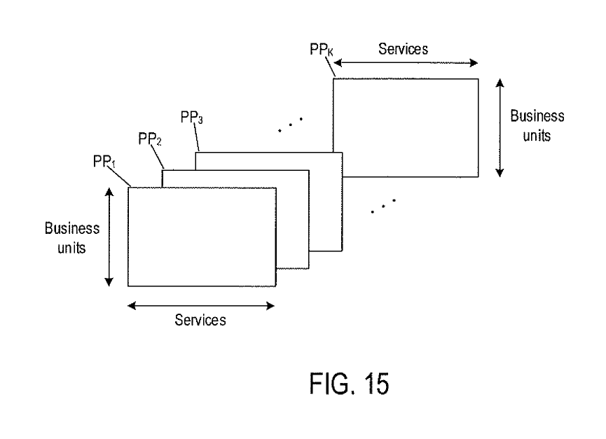

FIG. 15 shows a set of K price plans generated from a price plan policy. The price plans are denoted by PP₁, PP₂, . . . , PP_{K}. Each row of a price plan corresponds to a business unit, and each column of a price plan corresponds to a particular service provided by cloud-computing facility. Let, pₖ(i,j), represent a price in the k-th price plan, PPₖ, of the i-th service for the j-th business unit, where k=1, . . . , K; i=1, . . . , I; and j=1, . . . , J. The prices may range as follows:

p₁(i,j)<p₂(i,j)< . . . <p_{K}(i,j) (2)

where p₁(i,j) and p_{K}(i,j) are the minimum and maximum prices, respectively of the i-th service for the j-th business unit as defined by the price plan policy.

Next, given the set of K price plans, the price plan that maximizes a selected IT target function is determined. The price plans are tested in rounds over a period of time. In the first round, each of the price plans is evaluated by inputting the price plan to the customer agent, which uses resources according to the price plan. When the customer price plan evaluation is complete the value of the target function is calculated and serves as the reward. In subsequent rounds, one of the price plans is selected (i.e., systematically or at random) and the value of the target function observed is the reward. The rewards are denoted Rₖ(t), where k=1, . . . , K. Target Function is the function to optimize. For example, the reward Rₖ(t) represents the value of the target function for a test use of the k-th price plan PPₖ at round t of the period of time. The target function may be usage volume, maximum profit, or maximum recovery. Maximum profit corresponds to an optimal price plan that maximizes profit. Maximum recovery corresponds to 100% usage by consumer business units. Maximum usage volume corresponds to 100% usage by different consumers which are not necessarily an internal business unit but for example may be an external consumer.

Methods attempt to balance how much to exploit a known price plan and how much to explore new price plans that might better maximize the selected target function. Methods explore and exploit the various price plans and measure the effectiveness of each price plan as function of the target function (i.e., value of the reward) over a period of time while taking incremental steps resulting in convergence on an optimal price plan.

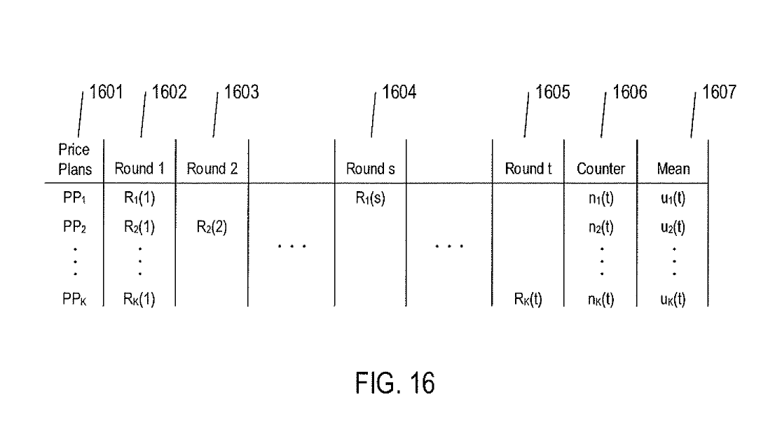

FIG. 16 shows a table of rewards for the set of K price plans. Column 1601 contains a list of the K price plans PP₁, PP₂, . . . , PP_{K} described above with reference to FIG. 15. Column 1602 contains a list of the rewards determined from test use of each of the K price plans for a first round. Columns 1603-1605 the reward determined from one of the set of K price plans selected in each round following the first round. For example, in the second round, a reward R₂(2) is determined for the price plan PP₂. In the s-th round, a reward R₁(s) is determined for the price plan PP₁. In the final t-th round, a reward R_{K}(t) is determined for the price plan PP_{K}. After the first round, a price plan may be systematically selected, such as according to a schedule, or a price plan may be selected at random. Column 1606 list counters denoted by nₖ(t) associated with each price plan. Each counter nₖ(t) is the number of times a price plan is systematically or randomly selected. Column 1607 list mean values of the rewards after t rounds.

The mean reward calculated for each price plan after t rounds is calculated as follows:

$${u}_{k} ( t ) = \frac{1}{{n}_{k} ( t )} {\sum }_{s = 1}^{t} {R}_{k} ( s ) \qquad ( 3 )$$

For each price plan, a weighted mean reward may be calculated according to

$${F}_{k} ( t ) = {u}_{k} ( t ) + \sqrt{\frac{2 ln t}{{n}_{k} ( t )}} \qquad ( 4 )$$

The index of the largest weighted mean reward is the index of the optimal price plan as represented by

$$j ( t ) = {argmax}_{k = 1 , … , K} ( {F}_{k} ( t ) ) \qquad ( 5 )$$

where “argmax” is the index in the set of indices {1, . . . , K} that is the largest weighted mean reward in the set of weighted mean reward values {Fₖ(t)}ₖ₌₁^{K}.

The value j(t) is the index in the set of indices {1, . . . , K} that corresponds to the largest weighted mean reward in the set of weighted mean reward values {Fₖ(t)ₖ₌₁^{K}}. The optimal price plan is given by PPⱼ₍ₜ₎.

After the optimal price plan has been determined, the price plan is used to charge the IT customer. A customer agent may then perform operations analysis over time in order to adjust usage of the cloud-computing resources based on a combination of performance and financial assessment conditions. The customer agent has access to the price plan and application state metrics. For example, when the following conditions are satisfied

Average Response time>SLA Response Time (6a)

Money Spent<Max Allowed Expence (6b)

Web Server Count<Max Allowed Web Servers (6c)

where SLA Response Time is the service-level agreement (“SLA”) response time

a new virtual web server is leased to the customer. As another example, when the following conditions

Average Response time<SLA Response Time (7a)

Money Spent−Max Allowed Expence≦100 (7b)

Web Server Count>Some number of Web Servers (7c)

are satisfied, the most expensive Web server is identified and returned to the IT service provider.

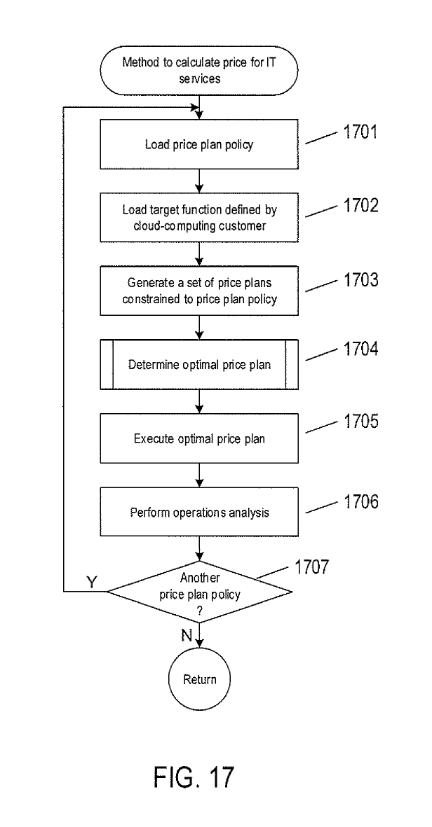

FIG. 17 shows a control-flow diagram of a method to calculate a price for IT services offered by an IT vendor of cloud computing services. In block 1701, a price plan policy is loaded, as described above with reference to FIG. 14. The price plan policy may be generated based on cost structures, competitor's prices, and profit margins for the service provider. In block 1702, a target function selected by an IT customer is loaded. The target function may be a usage volume target function, a profit target function, and a recover target function. Target function is used by the IT Vendor to target the search process of the optimal price plan. In block 1703, a number of different price plans constrained by the price plan policy are generated, as described above with reference FIG. 15. In block 1704, a routine “determine optimal price plan” is called to determine the optimal price plan in the set of price plans. In block 1705, the optimal price plan is used to charge or bill the IT customer for IT services. In block 1706, operations analysis based on performance and financial assessment conditions in order to assess usage of the cloud-computing resources. In decision block 1707, if another price plan is presented, the operations represented by blocks 1701-1706 are repeated.

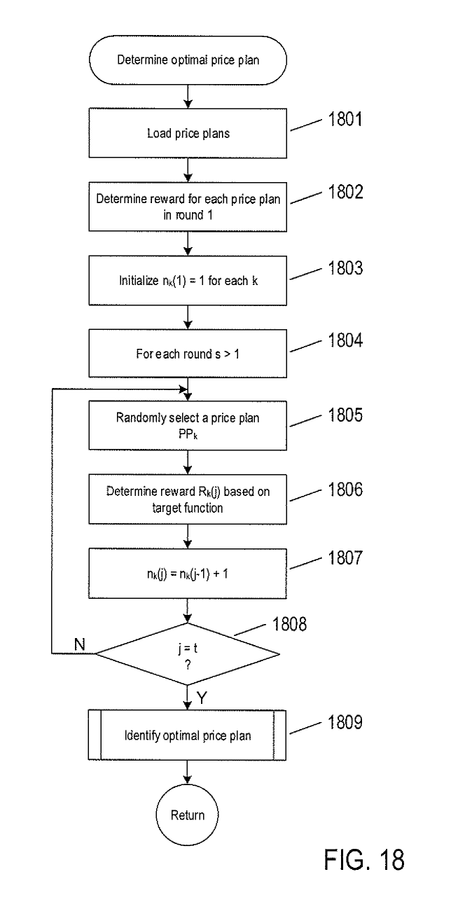

FIG. 18 shows a control-flow diagram of the routine “determine optimal price plan” called in block 1704 of FIG. 17. In block 1801, the set of price plans created in block 1703 of FIG. 17 is loaded. In block 1802, a target function value is determined for each price plan in round 1. The target function value may be usage volume, profit, or recovery and is the reward for the price plan. In block 1803, the counter associated with each price plan is initialized to one. A for-loop beginning with block 1804 repeats the operations represented by blocks 1805-1807 for each round within a period of time. In block 1805, one of the price plans is selected. The price plan may be selected at random or systematically selected. In block 1806, the target function value is determined for the price plan. The target function value determined for the price plan is the reward. In block 1807, the counter associated with the selected price plan is incremented. In decision block 1808, when t rounds have been completed, control flows to block 1809. In block 1809, a routine “identify optimal price plan” based on rewards associated with each price plan.

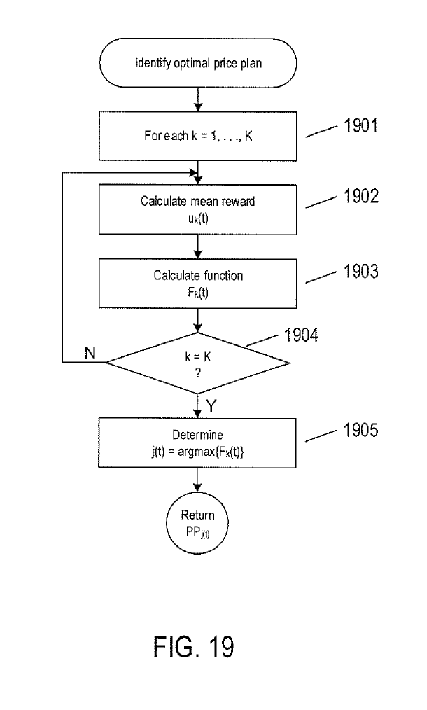

FIG. 19 shows a control-flow diagram of the routine “identify optimal price plan” called in block 1809 of FIG. 18. A for-loop beginning with block 1901 repeats the operations represented by blocks 1902 and 1903 for each of the price plans. In block 1902, the mean reward is the calculated for the k-th price plan based on the number of times the k-th price plan is selected. In block 1903, a weighted mean reward is calculated based on the mean reward and the number of times the k-th price plan is selected. In decision block 1904, when k does not equal K, the operations represented by blocks 1902 and 1903 are repeated for another mean reward. In block 1905, the index of the largest weighted mean reward is the index of the optimal price plan.

The search for optimal price plan described above balances between explore and exploit, which is an ongoing process. In other words, once an optimal price plan has been found, the price plan remains the optimal for some time. But, because conditions in a cloud computing infrastructure may changes, the offer and demand for IT services may change and the methods described above are run again to find a current optimal price plan. The methods may be kept continuously running in order to continually tune the optimal price plan.

It is appreciated that the various implementations described herein are intended to enable any person skilled in the art to make or use the present disclosure. Various modifications to these implementations will be readily apparent to those skilled in the art, and the generic principles defined herein may be applied to other implementations without departing from the spirit or scope of the disclosure. For example, any of a variety of different implementations can be obtained by varying any of many different design and development parameters, including programming language, underlying operating system, modular organization, control structures, data structures, and other such design and development parameters. Thus, the present disclosure is not intended to be limited to the implementations described herein but is to be accorded the widest scope consistent with the principles and novel features disclosed herein.

1. A method stored in one or more data-storage devices and executed using one or more processors of a computing environment to calculate pricing of information technology (“IT”) services provided by an IT vendor of cloud computing services, the method comprising:
generating a number of different price plans constrained by a price plan policy, each price plan policy defines price boundaries for each price of a different IT service;
determining a reward for each price plan, the target function value representing a reward that would result from using the associated price plan;
determining an optimal price plan of the price plans as the reward that maximizes a target function; and
executing to the optimal price plan to charge IT customers for IT services.

2. The method of claim 1 further comprising performing operations analysis based on performance and financial assessment conditions in order to assess usage of the cloud-computing resources.

3. The method of claim 1, wherein the price plan policy comprises cost structures, competitor pricing, and profit margins of the IT service provider.

4. The method of claim 1, wherein the target function comprises one of a usage volume target function, a profit target function, and a recover target function

5. The method of claim 1, wherein determining the target function value for each price plan further comprises:
determining a target function value for each price plan in a first round of a period of time;
in each round of the period of time,
selecting one of the price plans from the number of price plans, and
determining a reward for a test use of the price plan based on a value of the target function in the round;
calculating a mean reward based on the one or more rewards determined for each price plan and the number of times the price plan is selected;
calculating a weighted mean reward for each price plan based on the mean reward and the number of times the price plan is selected; and
calculating a weighted mean reward as a function of the number of times the price plan is selected over the period of time.

6. The method of claim 1, wherein determining the optimal price plan further comprises:
identifying a largest weighted mean reward; and
assigning the optimal price plan as the price plan with the largest associated weighted mean reward.

7. A system to calculate pricing of information technology (“IT”) services provided by an IT vendor of cloud computing services comprising:
one or more processors;
one or more data-storage devices; and
machine-readable instructions stored in the data-storage devices that when executed using the one or more processors controls the system to carry out
generating a number of different price plans constrained by a price plan policy, each price plan policy defines price boundaries for each price of a different IT service;
determining a reward for each price plan, the target function value representing a reward that would result from using the associated price plan;
determining an optimal price plan of the price plans as the reward that maximizes a target function; and
executing to the optimal price plan to charge IT customers for IT services.

8. The system of claim 7 further comprising performing operations analysis based on performance and financial assessment conditions in order to assess usage of the cloud-computing resources.

9. The system of claim 7, wherein price plan policy further comprises cost structures, competitor pricing, and profit margins of the IT service provider.

10. The system of claim 7, wherein the target function further comprises one of a usage volume target function, a profit target function, and a recover target function

11. The system of claim 7, wherein determining the target function value for each price plan further comprises:
determining a target function value for each price plan in a first round of a period of time;
in each round of the period of time,
selecting one of the price plans from the number of price plans, and
determining a reward for a test use of the price plan based on a value of the target function in the round;
calculating a mean reward based on the one or more rewards determined for each price plan and the number of times the price plan is selected;
calculating a weighted mean reward for each price plan based on the mean reward and the number of times the price plan is selected; and
calculating a weighted mean reward as a function of the number of times the price plan is selected over the period of time.

12. The system of claim 7, wherein determining the optimal price plan further comprises:
identifying a largest weighted mean reward; and
assigning the optimal price plan as the price plan with the largest associated weighted mean reward.

13. A non-transitory computer-readable medium encoded with machine-readable instructions that implement a method carried out by one or more processors of a computer system to perform the operations of
generating a number of different price plans constrained by a price plan policy, each price plan policy defines price boundaries for each price of a different IT service;
determining a reward for each price plan, the target function value representing a reward that would result from using the associated price plan;
determining an optimal price plan of the price plans as the reward that maximizes a target function; and
executing to the optimal price plan to charge IT customers for IT services.

14. The medium of claim 13 comprising performing operations analysis based on performance and financial assessment conditions in order to assess usage of the cloud-computing resources.

15. The medium of claim 13, wherein price plan policy further comprises cost structures, competitor pricing, and profit margins of the IT service provider.

16. The medium of claim 13, wherein the target function further comprises one of a usage volume target function, a profit target function, and a recover target function

17. The medium of claim 13, wherein determining the target function value for each price plan further comprises:
determining a target function value for each price plan in a first round of a period of time;
in each round of the period of time,
selecting one of the price plans from the number of price plans, and
determining a reward for a test use of the price plan based on a value of the target function in the round;
calculating a mean reward based on the one or more rewards determined for each price plan and the number of times the price plan is selected;
calculating a weighted mean reward for each price plan based on the mean reward and the number of times the price plan is selected; and
calculating a weighted mean reward as a function of the number of times the price plan is selected over the period of time.

18. The medium of claim 13, wherein determining the optimal price plan further comprises:
identifying a largest weighted mean reward; and
assigning the optimal price plan as the price plan with the largest associated weighted mean reward.
